(19) United States
(12) Patent Application Publication
(10) Pub. No.: US 2013/0063650 A1
(43) Pub. Date: Mar. 14, 2013

(54) CATADIOPTRIC SYSTEM AND IMAGE PICKUP APPARATUS EQUIPPED WITH SAME

(71) Applicants: Kazuhiko Kajiyama, Utsunomiya-shi (JP); Masayuki Suzuki, Utsunomiya-shi (JP); Yuji Katashiba, Utsunomiya-shi (JP)

(72) Inventors: Kazuhiko Kajiyama, Utsunomiya-shi (JP); Masayuki Suzuki, Utsunomiya-shi (JP); Yuji Katashiba, Utsunomiya-shi (JP)

(73) Assignee: CANON KABUSHIKI KAISHA, Tokyo (JP)

(21) Appl. No.: 13/609,677

(22) Filed: Sep. 11, 2012

(30) Foreign Application Priority Data
Sep. 14, 2011 (JP) 2011-200546

(51) Int. Cl. G02B 17/08; H04N 5/232

(52) U.S. Cl. 348/345; 359/365; 348/E05.045

(57) ABSTRACT

A catadioptric unit includes, in order from an object side to an image side, a first optical element including a first transmissive unit having positive refractive power disposed in the vicinity of an optical axis and, on the object side thereof, a first reflective unit disposed at an outer circumference relative to the first transmissive unit and having a reflective surface; and a second optical element including a second transmissive unit having negative refractive power in the vicinity of the optical axis and, on the image side thereof, a second reflective unit disposed at an outer circumference relative to the second transmissive unit and having a reflective surface. Radii of curvature of object-side and image-side surfaces of the second optical element, a thickness along the optical axis and a refractive index of a material of the second optical element are set to satisfy predetermined conditions.

### BACKGROUND OF THE INVENTION

1. Field of the Invention

The present invention relates to a catadioptric system which is appropriate for magnification and observation of an object and an image pickup apparatus equipped with the catadioptric system.

2. Description of the Related Art

In the related art, in pathologic examination, pathologic samples are directly observed with eyes by using an optical microscope. Recently, a virtual microscope for acquiring image data of pathologic samples to be observed on a display has been used. Since the image data of the pathologic sample can be observed on a display by using the virtual microscope, a plurality of persons can simultaneously observe the sample. In addition, if the virtual microscope is used, there are many advantages, for example, in that the image data can be shared with pathologists at remote sites.

However, in the case where the microscope has a small imaging area, a pathologic sample needs to be divided into a plurality of areas, so that a plurality of images corresponding to the plurality of areas is acquired by performing an imaging operation several times, and the images need to be connected to each other to form one image. Therefore, as the size of a pathologic sample is increased, the number of imaging operations is increased, and thus, there is a problem in that much time is taken to acquire the image data of the entire pathologic sample. Accordingly, in order to acquire the image data of the entire pathologic sample through a small number of imaging operations, the microscope needs to use an optical system having a wide imaging area. In addition, the optical system needs to have high resolving power in a visible light range.

Japanese Patent Publication No. 60-034737 discusses a dioptric system of which the aberration is effectively reduced over the entire visible light range and which is appropriate for observing biological cells or the like. In addition, Japanese Patent Application Laid-Open (Translation of PCT Application WO2005022204) No. 2007-514179 discusses a catadioptric system having high resolving power over the entire visible light range in order to inspect defects existing in an integrated circuit or a photomask. In addition, WO00/39623 discusses a catadioptric system which is appropriate for manufacturing a semiconductor device by exposing a fine pattern on a wide area by using light in an ultraviolet wavelength range.

However, in the optical system discussed in Japanese Patent Publication No. 60-034737, although various aberrations are effectively reduced over the entire visible light range, the size of an imaging area is not necessarily sufficient. In addition, in the optical system discussed in Japanese Patent Application Laid-Open (Translation of PCT Application) No. 2007-514179, although various aberrations are effectively reduced over the entire visible light range with high resolving power, the size of an imaging area is not necessarily sufficient. In addition, although the optical system discussed in WO00/39623 has high resolving power over a wide range, the wavelength range in which various aberrations are effectively corrected does not cover the entire visible light range and is thus not adequate for visible-light microcopy.

### SUMMARY OF THE INVENTION

According to an aspect of the present invention, a catadioptric system includes a catadioptric unit configured to collect a light flux from an object to form an intermediate image of the object, a field lens unit disposed at a position where the intermediate image is formed, and a dioptric unit configured to focus the intermediate image on an image plane, wherein the catadioptric unit includes, in order from an object side to an image side a first optical element including a first transmissive unit having positive refractive power disposed in the vicinity of an optical axis and, on the object side thereof, a first reflective unit disposed at an outer circumference relative to the first transmissive unit and having a reflective surface, and a second optical element including a second transmissive unit having negative refractive power in the vicinity of the optical axis and, on the image side thereof, a second reflective unit disposed at an outer circumference relative to the second transmissive unit and having a reflective surface, wherein the light flux from the object sequentially travels through the first transmissive unit, to the second reflective unit, to the first reflective unit, and to the second transmissive unit to exit toward the field lens unit, and wherein, when radii of curvature of an object-side surface and an image-side surface of the second optical element are denoted by RM2a and RM2b, respectively, a thickness of the second optical element along the optical axis is denoted by t, a refractive index of a material of the second optical element with respect to a wavelength of 587.6 nm is denoted by Nd, and following equations are defined:

$$\frac{1}{( \frac{\vert RM 2 b \vert}{2} )} - \frac{1}{( \vert RM 2 a \vert + t )} = \frac{1}{{s}^{′}}$$

$$\frac{( {s}^{′} - t ) \times Nd}{( Nd + 1 )} = Rapl$$

the following condition is satisfied:

Rapl×0.8<|RM2a|<Rapl×1.2.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic cross-sectional diagram illustrating a configuration of an image pickup apparatus according to an exemplary embodiment of the invention.

FIG. 2 is a schematic diagram illustrating main components of a catadioptric system according to a first exemplary embodiment of the invention.

FIG. 3 is a lateral aberration diagram illustrating the catadioptric system according to the first exemplary embodiment of the invention.

FIG. 4 is a schematic diagram illustrating main components of a catadioptric system according to a second exemplary embodiment of the invention.

FIG. 5 is a lateral aberration diagram illustrating the catadioptric system according to the second exemplary embodiment of the invention.

FIG. 6 is a schematic diagram illustrating main components of a catadioptric system according to a third exemplary embodiment of the invention.

FIG. 7 is a lateral aberration diagram illustrating the catadioptric system according to the third exemplary embodiment of the invention.

FIG. 8 is a schematic diagram illustrating main components of a catadioptric system according to a fourth exemplary embodiment of the invention.

FIG. 9 is a lateral aberration diagram illustrating the catadioptric system according to the fourth exemplary embodiment of the invention.

FIGS. 10A and 10B illustrate a first and second optical element, respectively, and surfaces thereof.

### DESCRIPTION OF THE EMBODIMENTS

Various exemplary embodiments, features, and aspects of the invention will be described in detail below with reference to the drawings.

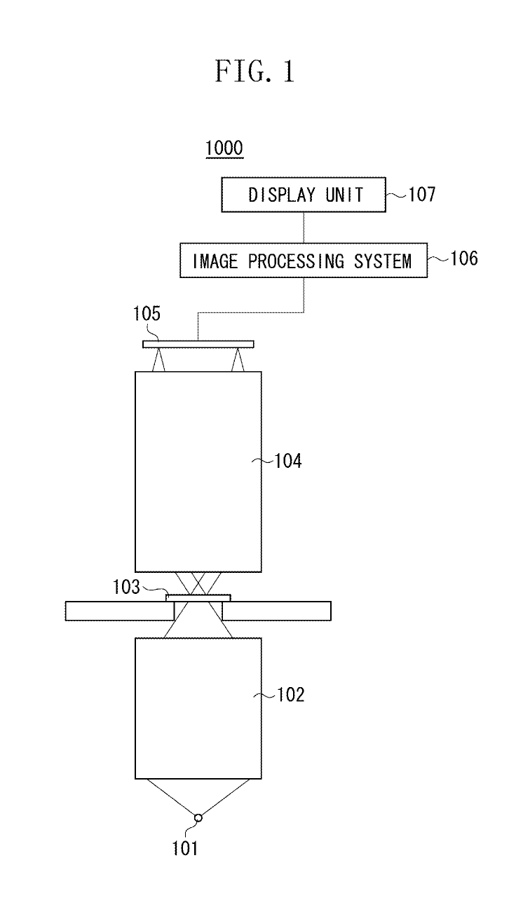

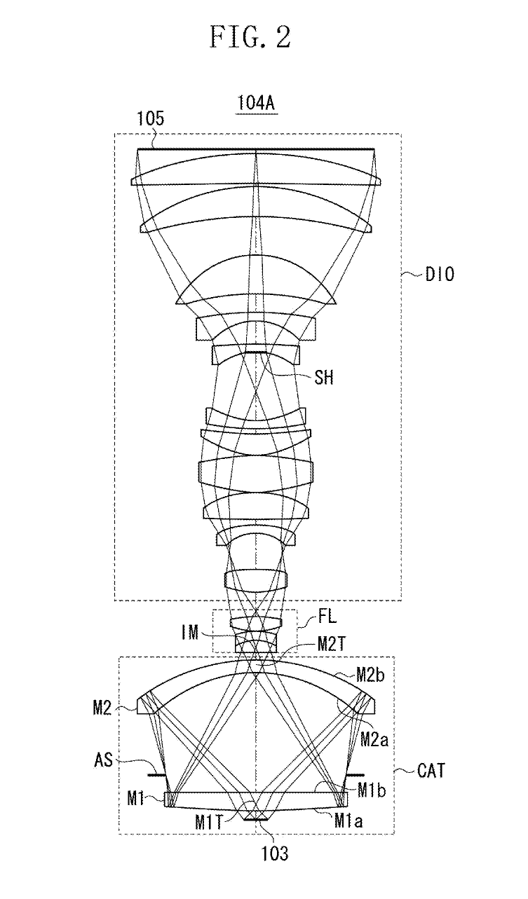

As illustrated in FIGS. 1 and 2, a catadioptric system 104 according to an exemplary embodiment of the invention is configured to include a catadioptric unit CAT which collects a light flux from an object 103 to form an intermediate image IM of the object, and a field lens unit FL which is disposed at a position where the intermediate image IM is formed. The catadioptric system 104 is configured to further include a dioptric unit DIO which focuses the intermediate image IM on an image plane IP, where an image sensor 105 is located. FIG. 1 illustrates an image pickup apparatus 1000 according to an embodiment of the invention is configured to include a light source unit 101, an illumination optical system 102 which illuminates the object 103 with a light flux from the light source unit 101, and the catadioptric system 104 which focuses the image of the object 103. The image pickup apparatus 1000 is configured to further include an image sensor 105 which photo-electrically converts the object image focused by the catadioptric system 104 and an image processing system 106 which generates image information from data of the image sensor 105. A display unit 107 serves to display the image generated by the image processing system 106.

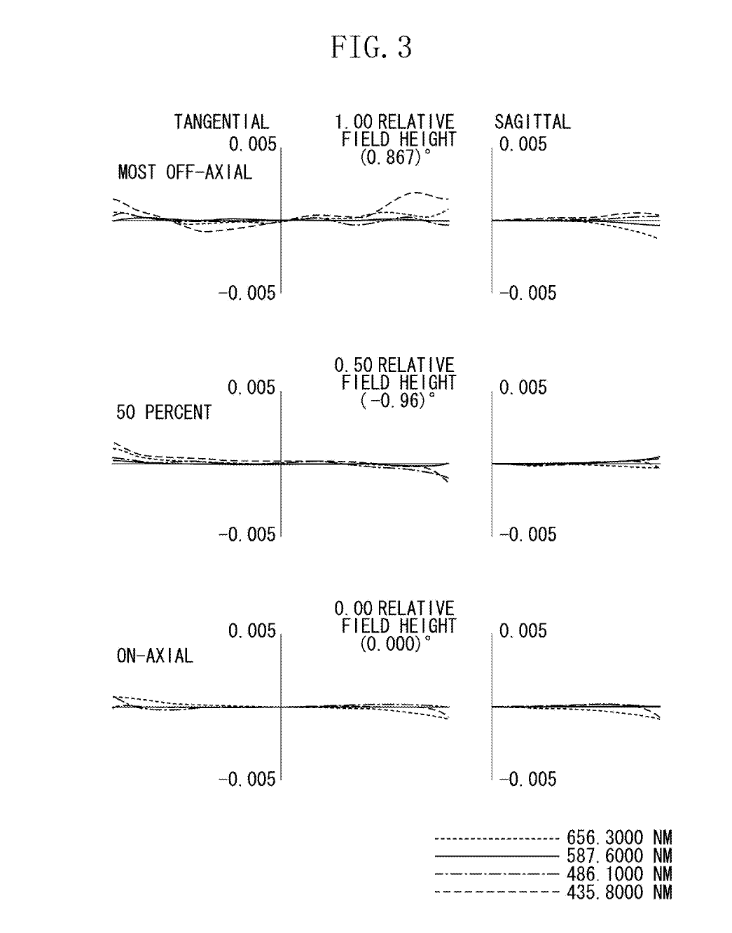

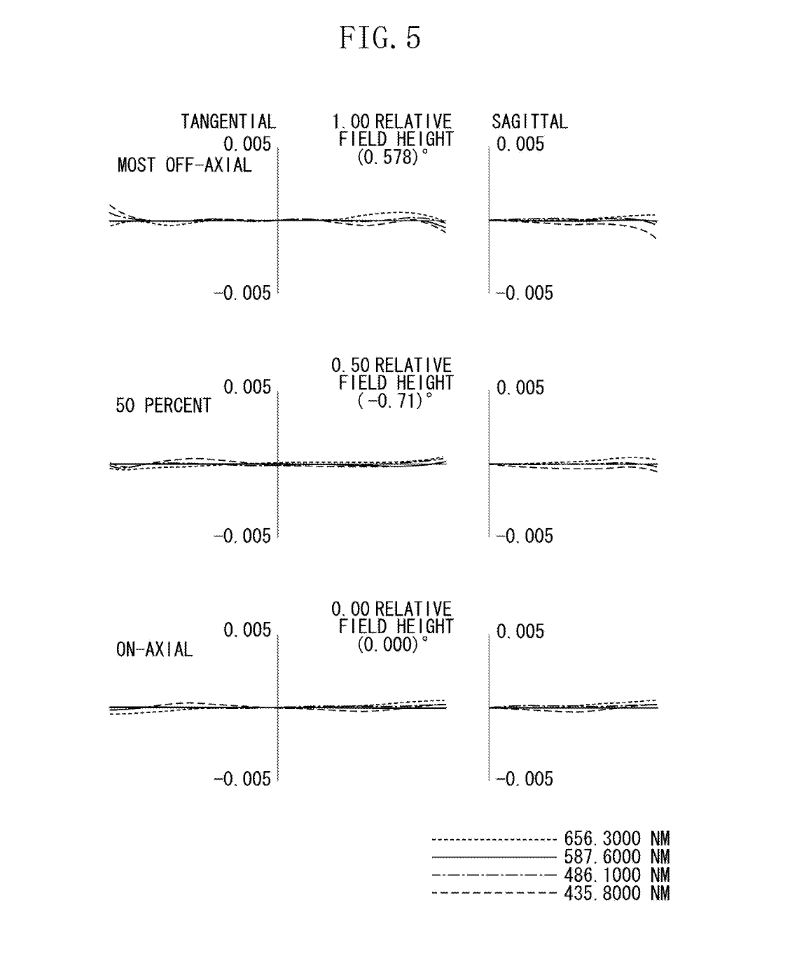

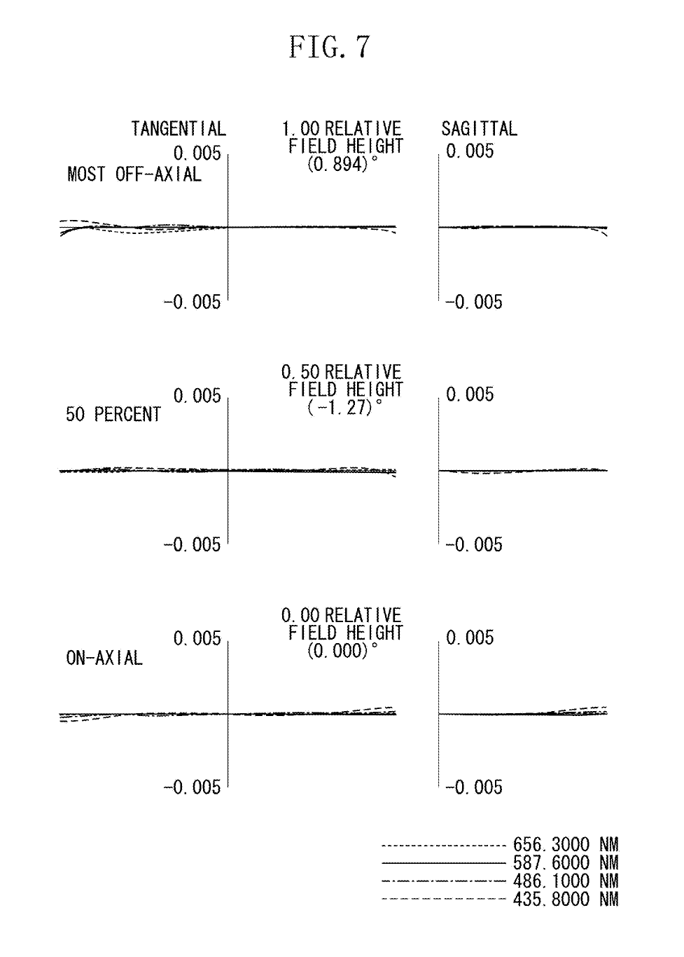

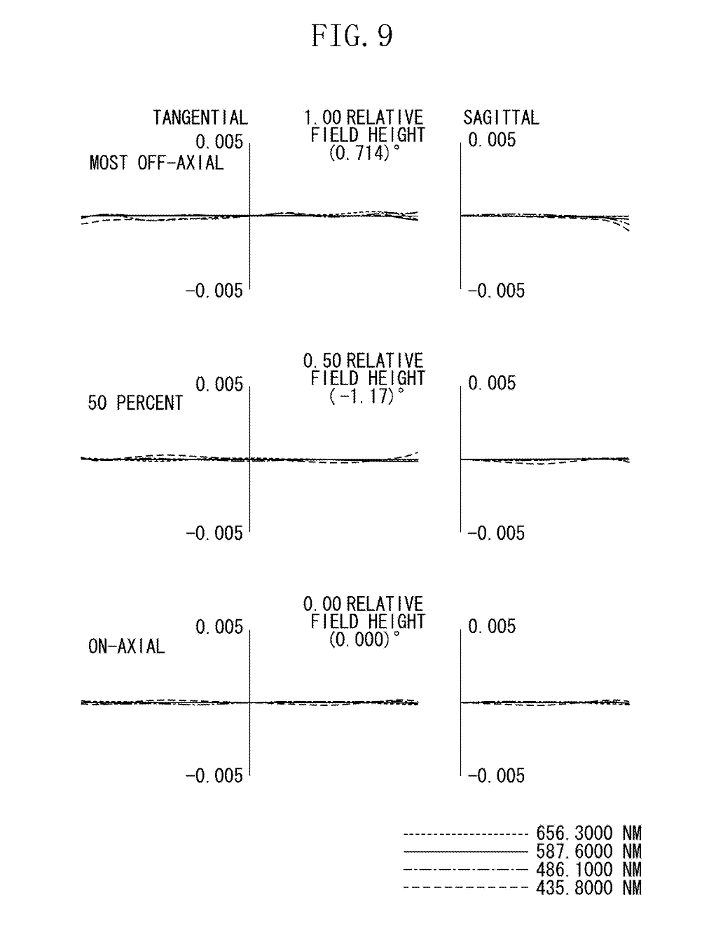

Lateral aberration diagrams of FIGS. 3, 5, 7, and 9 illustrate results of calculation of aberration on the sample 103 in units of millimeters with respect to a center wavelength of 587.6 nm, a wavelength of 656.3 nm, a wavelength of 486.1 nm, and a wavelength of 435.8 nm, respectively.

Hereinafter, the configuration of the image pickup apparatus 1000 including the catadioptric system 104 according to the embodiment of the invention will be described with reference to FIG. 1. In the image pickup apparatus 1000, the light from the light source unit 101 is collected by the illumination optical system 102, and the sample (object) 103 is illuminated with the light. At this time, visible light (for example, in a wavelength range from 400 nm to 700 nm) is used. The catadioptric system 104 focuses the image of the sample (object) 103 on the image sensor 105. The image processing system 106 generates image data from signals (image information) acquired by the image sensor 105, and the generated image data are displayed on the display (display unit) 107 or the like. The image processing system 106 performs a process according to the use such as correction of aberration which cannot be corrected by the catadioptric system 104 or composition of one-sheet image data through connection of image data of different imaging positions.

As illustrated in FIGS. 2, 4, 6, and 8, the catadioptric system 104 according to each embodiment is configured to include the catadioptric unit CAT having a reflective surface and a refractive surface, which collects a light flux of the sample (object) 103 to form an intermediate image IM on a predetermined plane. In addition, the catadioptric system 104 is configured to include a field lens unit FL which collects the light flux from the intermediate image IM to guide the light in the direction of the dioptric unit DIO described below and the dioptric unit DIO which focuses the intermediate image IM on the image sensor (image plane) 105.

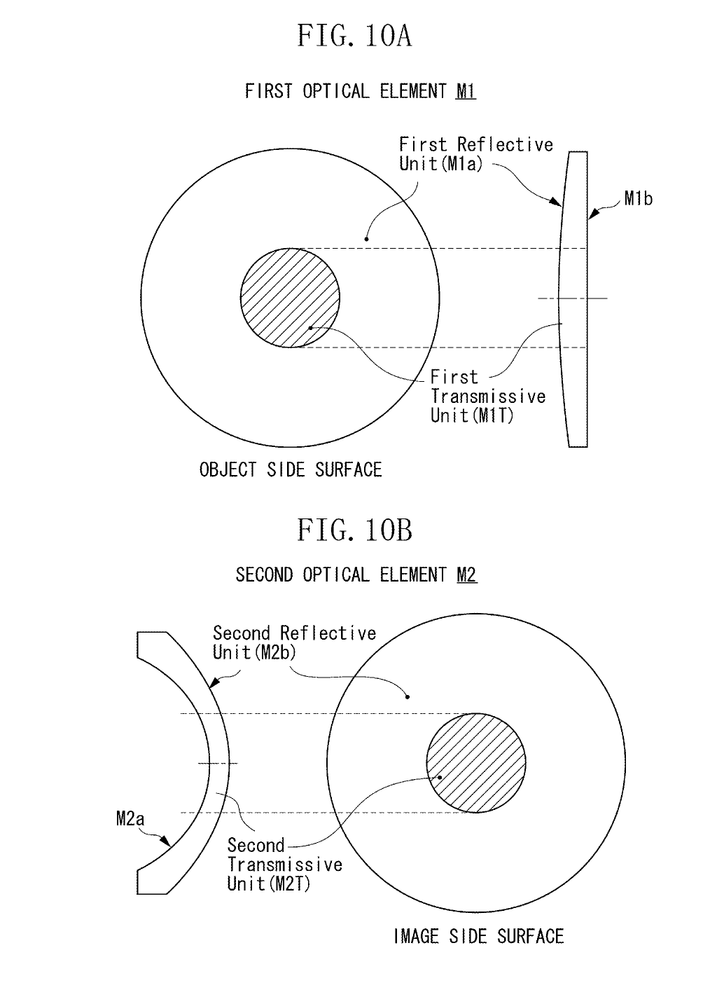

The catadioptric unit CAT configuring the catadioptric system 104 is configured to include, in order from the object side to the image side, at least a first optical element M1 and a second optical element M2. As illustrated in FIG. 10A, the first optical element M1 is configured to include: a light transmissive unit M1T (first transmissive unit), and a surface M1a facing the sample 103 (object side surface) has a convex shape and of which the vicinity of the optical axis has positive refractive power; and a rear-surface reflective unit (first reflective unit) in which a reflective surface (for example, a reflective film of aluminum, silver, or the like) is formed on the surface M1a at the sample (103) side at the outer circumference thereof. As illustrated in FIG. 10B, the second optical element M2 is configured to include: a light transmissive unit M2T (second transmissive unit) which has a meniscus shape having a concave surface facing the sample 103 (object side surface) and of which the vicinity of the optical axis has negative refractive power; and a rear-surface reflective unit (second reflective unit) in which a reflective surface (for example, a reflective film of aluminum, silver, or the like) is formed on a surface M2b at the image sensor (105) side (image plane side) at the outer circumference thereof. The reflective surface of the rear-surface reflective unit of the first optical element M1 and the reflective surface of the rear-surface reflective unit of the second optical element M2 are disposed to face each other.

The dioptric unit DIO includes a light blocking plate SH. The light blocking plate SH blocks the light flux in the vicinity of the optical axis, which is not reflected by the surfaces M1a and M2b but directly passes through the light transmissive units M1T and M2T among the light flux from the sample 103, so as to reduce the light incident to the image sensor 105. At this time, since the image formability is deteriorated as the area of blocking the light is increased, it is important to maintain the ratio of blocking light (hereinafter, referred to as a light blocking ratio) to be as low as possible.

In the catadioptric system 104 of each embodiment, illumination of the sample 103 is performed with the light flux emitted from the light source 101 and focused with the illumination optical system 102. The light flux modulated by the sample 103 passes through the light transmissive unit M1T of the first optical element M1. Next, the light is incident to the refractive surface M2a of the second optical element M2, and after that, the light is reflected by the rear surface M2b and passes through the reflective surface M2a to be incident to the refractive surface M1b of the first optical element M1. Next, the light is reflected by the rear surface M1a of the first optical element M1. Next, the light passes through the refractive surface M1b and passes through the light transmissive unit M2T of the second optical element M2 to exit toward the field lens unit (FL) side, so that the intermediate image IM of the sample 103 is formed. The intermediate image IM is formed within the lens configuring the field lens unit FL. The intermediate image IM is magnified and focused on the image sensor 105 by the dioptric unit DIO including a plurality of refractive optical elements. The image of the sample 103 focused on the image sensor 105 is processed by the image processing system 106 to be displayed on the display unit 107.

In each embodiment, radii of curvature of the object-side and image-side surfaces M2a and M2b of the second optical element M2 are denoted by RM2a and RM2b, respectively. A thickness of the second optical element M2 along the optical axis is denoted by t. A refractive index of a material of the second optical element M2 with respect to a wavelength of 587.6 nm is denoted by Nd. Accordingly, when the following equations are defined:

$$\begin{matrix}\frac{1}{( \frac{\vert RM 2 b \vert}{2} )} - \frac{1}{( \vert RM 2 a \vert + t )} = \frac{1}{{s}^{′}} & ( a 1 ) \\ \frac{( {s}^{′} - t ) \times Nd}{( Nd + 1 )} = Rapl & ( a 2 )\end{matrix}$$

it is useful that the following condition be satisfied:

Rapl×0.8<|RM2a|<Rapl×1.2 (1)

In addition, an Abbe number of a glass material of the second optical element M2 is denoted by νM2. At this time, the following condition is satisfied:

νM2>40 (2)

The condition (1) is set so that, although the object-side surface M2a of the second optical element M2 has strong negative refractive power, the occurrence of aberration is suppressed, and thus, the aberration is reduced over a wide wavelength range. In order to achieve the following optical effects, it is important to have a strong divergence function due to the strong negative refractive power of the refractive surface M2a of the second optical element M2.

The light transmissive unit disposed substantially the center (in the vicinity of the optical axis) of the first optical element M1 having a positive lens function can be relatively small in comparison with the effective diameter, so that the light blocking ratio can be suppressed to be low.

Since the axial chromatic aberration of the catadioptric unit CAT and the axial chromatic aberration of the dioptric unit DIO can cancel each other out, the convex-lens power (refractive power of a positive lens) of the dioptric unit DIO can be strong, so that it is possible to easily reduce the total length.

Herein, the equation (a1) is an equation regarding an image forming relation with respect to the reflective surface M2b. More specifically equation (a1) represents that an object point is at the center of curvature of the refractive surface M2a, and an image point is located at the position of a distance S′ away from the reflective surface M2b on the image side thereof. The equation (a2) relates to an object point of a virtual image at the position of the distance S′ away from the reflective surface M2b and represents the radius of curvature Rapl for the condition that the refractive surface M2a is aplanatic.

The condition (1) represents how much the refractive surface M2a is shifted from the radius of curvature Rapl for the condition that the refractive surface M2a is aplanatic. In the condition (1), there is somewhat a margin. This is because balance is to be kept with aberration occurring from other surfaces. Therefore, it is useful that the condition (1) be satisfied in order to keep balance with the first optical element M1. If the condition (1) is not satisfied, large aberration occurs due to the refractive surface M2a of the second optical element M2, so that it is difficult to effectively reduce the aberration over a wide wavelength range.

The condition (2) represents that the glass material of the second optical element M2 has low dispersion. The condition (2) is configured so as to reduce secondary axial chromatic aberration. In a general dioptric system, in order to form an image of an object, the power of a positive lens is designed to be stronger than the power of a negative lens. Therefore, a low-dispersion glass material is used for the positive lens, and a high-dispersion glass material is used for the negative lens, so that the correction of chromatic aberration is performed. At this time, since the low-dispersion glass material and the high-dispersion glass material have different rates of change in refractive index with respect to wavelength, secondary chromatic aberration occurs. On the other hand, in the catadioptric system according to the embodiment, although the power (refractive power) of the negative refractive surface M2a of the second optical element M2 is configured to be large, an image can be formed by strengthening the power of the reflective surface M2b where the chromatic aberration does not occur. Therefore, by using a low-dispersion (large Abbe number) glass material as the second optical element M2, it is possible to reduce the secondary axial chromatic aberration. If the condition (2) is not satisfied, the secondary axial chromatic aberration cannot be reduced, so that it is difficult to effectively reduce the aberration in a wide wavelength range.

In each embodiment, if the three equations, that is, the equations (a1) and (a2) and the condition (1) are satisfied, the configuration can be obtained that the aberration at the refractive surface M2a is effectively reduced as follows.

The light beam which is to be first incident to the refractive surface M2a is incident at substantially 0 degrees.

When the light beam reflected by the reflective surface M2b exits from the refractive surface M2a, the condition is satisfied that the radius of curvature of the refractive surface M2a is aplanatic.

In each embodiment, the aberration is reduced by the refractive surface M2a having the largest effective diameter, so that it is easy to effectively reduce the aberration over a wide wavelength range.

More desirably, numeric values of the conditions (1) and (2) may be set as follows:

Rapl×0.9<|RM2a|<Rapl×1.1 (1a)

νM2>50 (2a)

In addition, it is useful that the reflective surface of the second optical element M2 have an aspheric shape, and the curvature is smooth (continuous or uninterrupted) over a range from the outer edge of light transmissive unit (M2T) to the outer edge of the outer circumference. According to this setting, the occurrence of chromatic aberration is reduced, and spherical aberration is effectively corrected.

FIG. 2 is a cross-sectional diagram illustrating main components of a catadioptric system 104A according to a first exemplary embodiment of the invention. In the catadioptric system according to the first exemplary embodiment, a numerical aperture NA of the object side is 0.7; imaging magnification is 10; an object height of a sample 103 is φ14 mm; and an aperture stop AS is disposed to a catadioptric unit CAT. According to the configuration where the aperture stop AS is disposed to the catadioptric unit CAT, although the diameter of the stop is increased in comparison with the case where the aperture stop AS is disposed to the dioptric unit, distortion of pupil can be reduced.

In the catadioptric system 104A, the object side and the image plane side are configured to be telecentric, and thus, the light blocking ratio is suppressed to be equal to or less than 20% in terms of an area ratio. In addition, the worst value of wavefront aberration with respect to white light is suppressed to be equal to or less than 50 mλ (rms).

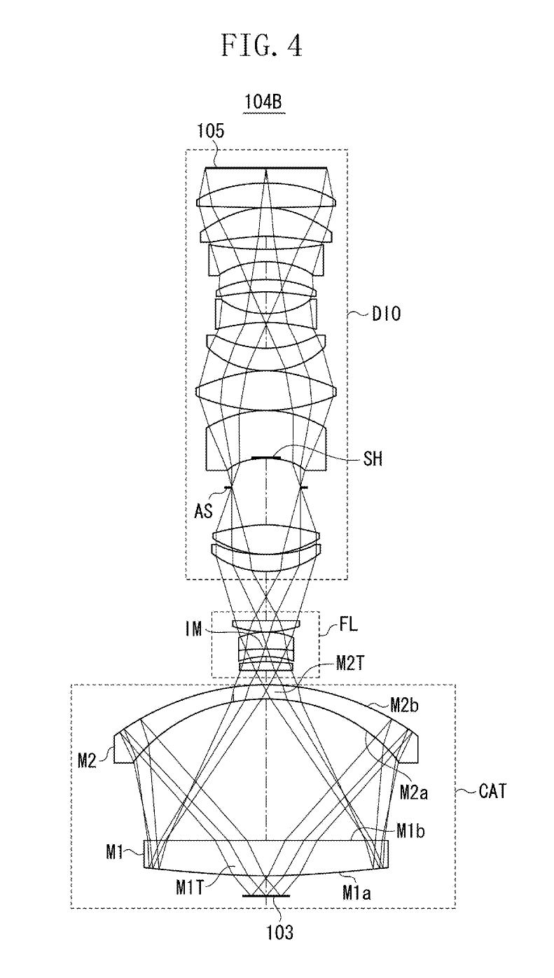

FIG. 4 is a cross-sectional diagram illustrating main components of a catadioptric system 104B according to a second exemplary embodiment. In FIG. 4, the same elements as those of FIG. 2 are denoted by the same reference numerals. The configuration of the second exemplary embodiment is substantially the same as that of the first exemplary embodiment.

In the optical system according to the second exemplary embodiment, a numerical aperture NA of the object side is 0.7; imaging magnification is 4; an object height of a sample 103 is φ20 mm; and unlike the first exemplary embodiment, an aperture stop AS is disposed to a dioptric unit DIO. The object side and the image plane side are configured to be telecentric, and thus, the light blocking ratio is suppressed to be equal to or less than 20% in terms of an area ratio. In addition, the worst value of wavefront aberration with respect to white light is suppressed to be equal to or less than 50 mλ (rms).

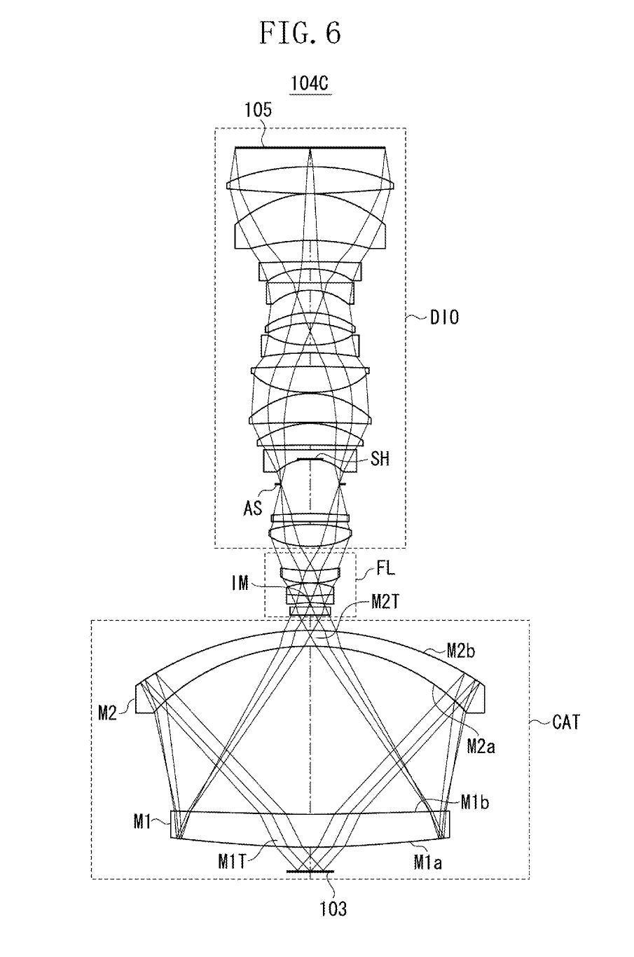

FIG. 6 is a cross-sectional diagram illustrating main components of a catadioptric system 104C according to a third exemplary embodiment of the invention. In FIG. 6, the same elements as those of FIG. 2 are denoted by the same reference numerals. The configuration of the third exemplary embodiment is substantially the same as that of the first exemplary embodiment.

In the optical system according to the third exemplary embodiment, a numerical aperture NA of the object side is 0.7; imaging magnification is 6; an object height of a sample 103 is φ17.5 mm; and unlike the first exemplary embodiment, an aperture stop AS is disposed to a dioptric unit DIO. The object side and the image plane side are configured to be telecentric, and thus, the light blocking ratio is suppressed to be equal to or less than 20% in terms of an area ratio. In addition, the worst value of wavefront aberration with respect to white light is suppressed to be equal to or less than 100 mλ (rms).

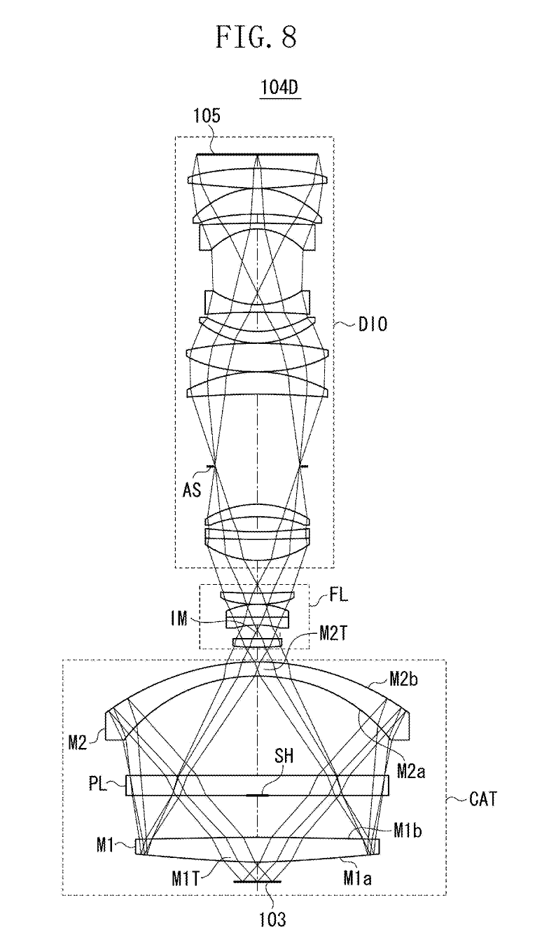

FIG. 8 is a cross-sectional diagram illustrating main components of a catadioptric system 104D according to a fourth exemplary embodiment. In FIG. 8, the same elements as those of FIG. 2 are denoted by the same reference numerals. The fourth exemplary embodiment is different from the first exemplary embodiment in terms of the configuration of a catadioptric unit CAT. In the fourth exemplary embodiment, a parallel plate PL is disposed between the first and second optical elements M1 and M2 configuring the catadioptric unit CAT. A light flux from a sample 103 passes through the parallel plate PL twice to exit toward a field lens unit (FL) side.

In the embodiment, a light blocking plate SH is disposed at the center of the parallel plate PL, so that the light flux in the vicinity of the optical axis is blocked before the light flux reaches the dioptric unit DIO. Therefore, unnecessary light occurring in the dioptric unit DIO can be reduced.

In addition, according to a mechanism for slanting the parallel plate PL, it is possible to adjust coma due to eccentricity caused in the manufacturing period.

In the optical system according to the fourth exemplary embodiment, a numerical aperture NA of the object side is 0.7; magnification is 4; an object height of a sample 103 is φ20 mm; and unlike the first exemplary embodiment, an aperture stop AS is disposed to a dioptric unit DIO. The object side and the image plane side are configured to be telecentric, and thus, the light blocking ratio is suppressed to be equal to or less than 20% in terms of an area ratio. In addition, the worst value of wavefront aberration with respect to white light is suppressed to be equal to or less than 50 mλ (rms).

The invention can be adapted to an image pickup apparatus for imaging a large sample by scanning and an image pickup apparatus for imaging a sample without scanning.

Hereinafter, numerical examples of the embodiments are listed. Surface Number denotes an order of an optical surface counted from an object plane (plane of a sample) to an image plane. r denotes a radius of curvature of the i-th optical surface. d denotes a distance between the i-th surface and the (i+1)-th surface (with respect to the sign, the direction of measurement from the object side to the image plane side (the direction of approaching light) is defined as positive, and the opposite direction is defined as negative).

Nd and νd denote a refractive index and Abbe number of a material with respect to a wavelength of 587.6 nm, respectively.

An aspheric shape is expressed by a general equation of an aspheric surface represented by the following equation. In the following equation, Z, c, h, and k denote a coordinate in an optical axis direction, a curvature (reciprocal of a radius of curvature r), a height from an optical axis, and a conic coefficient, respectively; and a, b, c, d, e, f, g, h, i, . . . denote the 4th, 6th, 8th, 10th, 12th, 14th, 16th, 18th, 20th, and . . . aspheric coefficients, respectively.

$$Z = \frac{{ch}^{2}}{1 + \sqrt{( 1 + k )} {c}^{2} {h}^{2}} + {ah}^{4} + {bh}^{6} + {ch}^{8} + {dh}^{10} + {eh}^{12} + {fh}^{14} + {gh}^{16} + {hh}^{18} + {ih}^{20} + …$$

“E-X” denotes “10^{-X}”. Relationship between the aforementioned conditions and numerical examples is listed in Table 1.

### NUMERICAL EXAMPLE 1

Rapl = 87.52
RM2a = −87.05
νM2 = 40.75

| Surface | | | | |
|---|---|---|---|---|
| Number | r | d | Nd | νd |
| Object | | 5.31 | | |
| Plane | | | | |
| 1 | 572.96 | 11.74 | 1.52 | 64.14 |
| 2 | −3971.93 | 70.93 | | |
| 3 | −87.05 | 7.37 | 1.58 | 40.75 |
| 4 | −115.96 | −7.37 | 1.58 | 40.75 |
| 5 | −87.05 | −60.93 | | |
| 6 | Aperture | −10.00 | | |
| | Stop | | | |
| 7 | −3971.93 | −11.74 | 1.52 | 64.14 |
| 8 | 572.96 | 11.74 | 1.52 | 64.14 |
| 9 | −3971.93 | 70.93 | | |
| 10 | −87.05 | 7.37 | 1.58 | 40.75 |
| 11 | −115.96 | 4.40 | | |
| 12 | −280.62 | 7.55 | 1.73 | 45.75 |
| 13 | −24.25 | 5.00 | 1.76 | 27.58 |
| 14 | −63.13 | 0.50 | | |
| 15 | 44.30 | 8.03 | 1.62 | 60.32 |
| 16 | −134.04 | 15.13 | | |
| 17 | 64.29 | 14.17 | 1.56 | 58.80 |
| 18 | −57.90 | 20.93 | | |
| 19 | −26.52 | 5.00 | 1.70 | 33.94 |
| 20 | −60.24 | 3.37 | | |
| 21 | 2035.38 | 15.68 | 1.63 | 35.46 |
| 22 | −70.44 | 0.89 | | |
| 23 | 117.93 | 21.53 | 1.68 | 39.58 |
| 24 | −74.17 | 0.50 | | |
| 25 | 56.79 | 12.02 | 1.74 | 30.97 |
| 26 | 177.00 | 3.06 | | |
| 27 | 165.39 | 5.00 | 1.76 | 27.58 |
| 28 | 53.42 | 40.67 | | |
| 29 | −38.60 | 5.00 | 1.76 | 27.58 |
| 30 | −229.85 | 13.99 | | |
| 31 | −35.70 | 5.00 | 1.76 | 27.58 |
| 32 | −181.79 | 11.22 | | |
| 33 | −143.30 | 22.66 | 1.52 | 53.64 |
| 34 | −56.43 | 23.57 | | |
| 35 | −219.04 | 17.88 | 1.75 | 34.24 |
| 36 | −110.37 | 1.09 | | |
| 37 | −4269.61 | 17.81 | 1.63 | 57.69 |
| 38 | −282.70 | 3.00 | | |
| Image | | | | |
| Plane | | | | |

Aspheric Coefficient

| Surface | | | | | | | | |
|---|---|---|---|---|---|---|---|---|
| Number | k | a | b | c | d | e | f | g |
| 1, 8 | 0.00E+00 | 2.87E−08 | −2.21E−12 | 1.43E−15 | −3.23E−19 | 6.13E−23 | −7.84E−27 | 5.67E−31 |
| 4, 11 | 0.00E+00 | 1.38E−08 | 1.43E−12 | 1.18E−16 | 9.15E−21 | 1.75E−24 | −1.32E−28 | 2.36E−32 |
| 15 | 0.00E+00 | −2.86E−06 | −1.71E−10 | −2.54E−11 | 1.25E−13 | −1.87E−16 | −1.09E−19 | 0.00E+00 |
| 20 | 0.00E+00 | −2.72E−06 | 5.72E−10 | 1.13E−12 | 3.49E−15 | −1.07E−17 | 7.33E−21 | 0.00E+00 |
| 22 | 0.00E+00 | −6.13E−07 | −1.96E−09 | 4.05E−13 | 7.53E−16 | −2.76E−19 | −1.97E−23 | 0.00E+00 |
| 24 | 0.00E+00 | 2.84E−06 | 9.47E−10 | −4.16E−13 | −3.31E−16 | 2.21E−19 | −3.12E−23 | 0.00E+00 |

### NUMERICAL EXAMPLE 2

Rapl = 147.19
RM2a = −118.31
νM2 = 70.24

| Surface | | | | |
|---|---|---|---|---|
| Number | r | d | Nd | νd |
| Object | | 13.39 | | |
| Plane | | | | |
| 1 | 736.61 | 24.08 | 1.49 | 70.24 |
| 2 | −9661.75 | 97.67 | | |
| 3 | −118.31 | 9.38 | 1.49 | 70.24 |
| 4 | −170.29 | −9.38 | 1.49 | 70.24 |
| 5 | −118.31 | −97.67 | | |
| 6 | −9661.75 | −24.08 | 1.49 | 70.24 |
| 7 | 736.61 | 24.08 | 1.49 | 70.24 |
| 8 | −9661.75 | 97.67 | | |
| 9 | −118.31 | 9.38 | 1.49 | 70.24 |
| 10 | −170.29 | 10.00 | | |
| 11 | −458.41 | 5.89 | 1.64 | 58.37 |
| 12 | −119.83 | 3.29 | | |
| 13 | −54.79 | 5.00 | 1.65 | 33.79 |
| 14 | −998.82 | 11.55 | 1.62 | 60.25 |
| 15 | −54.52 | 0.73 | | |
| 16 | 79.77 | 7.04 | 1.62 | 60.29 |
| 17 | 483.74 | 34.05 | | |
| 18 | 59.02 | 11.53 | 1.76 | 40.10 |
| 19 | 109.31 | 0.50 | | |
| 20 | 65.70 | 20.52 | 1.49 | 70.35 |
| 21 | −118.81 | 26.00 | | |
| 22 | Aperture | 18.84 | | |
| | Stop | | | |
| 23 | −49.26 | 33.31 | 1.81 | 25.43 |
| 24 | −79.27 | 0.50 | | |
| 25 | 122.53 | 26.67 | 1.64 | 55.38 |
| 26 | −86.46 | 0.50 | | |
| 27 | 57.90 | 15.51 | 1.49 | 70.35 |
| 28 | 78.67 | 17.39 | | |
| 29 | −124.44 | 5.74 | 1.57 | 42.86 |
| 30 | 58.49 | 15.64 | | |
| 31 | −147.56 | 8.96 | 1.76 | 47.82 |
| 32 | −75.81 | 11.90 | | |
| 33 | −59.72 | 8.10 | 1.60 | 38.03 |
| 34 | 272.55 | 9.12 | | |
| 35 | −178.62 | 19.27 | 1.72 | 34.72 |
| 36 | −68.40 | 0.50 | | |
| 37 | 1362.89 | 16.90 | 1.51 | 60.49 |
| 38 | −142.77 | 10.50 | | |
| Image | | | | |
| Plane | | | | |

Aspheric Coefficient

| Surface | | | | | | | | |
|---|---|---|---|---|---|---|---|---|
| Number | k | a | b | c | d | e | f | g |
| 1, 7 | 0.00E+00 | 6.72E−09 | 6.14E−14 | 2.27E−17 | −9.74E−22 | 1.18E−25 | −5.31E−30 | 2.75E−34 |
| 4, 10 | 0.00E+00 | 5.58E−09 | 2.43E−13 | 9.28E−1B | 1.61E−22 | 2.65E−26 | −9.34E−31 | 5.28E−35 |
| 17 | 0.00E+00 | 6.69E−07 | −6.19E−11 | 3.77E−14 | −1.71E−16 | 1.20E−19 | 0.00E−00 | 0.00E+00 |
| 19 | 0.00E+00 | 9.53E−07 | 2.89E−10 | 2.54E−14 | −5.14E−18 | 5.40E−21 | 0.00E+00 | 0.00E+00 |
| 26 | 0.00E+00 | 4.94E−07 | 1.25E−11 | 2.56E−15 | −9.15E−19 | 1.58E−22 | 0.00E+00 | 0.00E+00 |
| 30 | 0.00E+00 | 1.32E−06 | 1.83E−10 | −1.01E−13 | −2.77E−18 | −2.19E−21 | 0.00E+00 | 0.00E+00 |
| 38 | 0.00E+00 | −6.34E−07 | 9.02E−12 | −3.52E−14 | 9.13E−18 | −1.34E−21 | 0.00E+00 | 0.00E+00 |

### NUMERICAL EXAMPLE 3

Rapl = 142.21
RM2a = −167.82
νM2 = 52.43

| Surface | | | | |
|---|---|---|---|---|
| Number | r | d | Nd | νd |
| Object | | 13.72 | | |
| Plane | | | | |
| 1 | 770.39 | 22.33 | 1.52 | 58.90 |
| 2 | 2378.98 | 111.82 | | |
| 3 | −167.82 | 11.37 | 1.52 | 52.43 |
| 4 | −207.81 | −11.37 | 1.52 | 52.43 |
| 5 | −167.82 | −111.82 | | |
| 6 | 2378.98 | −22.33 | 1.52 | 58.90 |
| 7 | 770.39 | 22.33 | 1.52 | 58.90 |
| 8 | 2378.98 | 111.82 | | |
| 9 | −167.82 | 11.37 | 1.52 | 52.43 |
| 10 | −207.81 | 5.32 | | |
| 11 | −93.86 | 16.27 | 1.74 | 44.85 |
| 12 | −69.67 | 8.31 | | |
| 13 | −61.43 | 9.19 | 1.76 | 27.58 |
| 14 | 144.61 | 9.27 | 1.63 | 57.85 |
| 15 | −53.51 | 0.50 | | |
| 16 | 47.71 | 14.72 | 1.62 | 60.32 |
| 17 | 140.40 | 11.60 | | |
| 18 | 57.13 | 21.31 | 1.70 | 48.31 |
| 19 | −40.24 | 6.48 | 1.67 | 32.07 |
| 20 | −89.71 | 16.86 | | |
| 21 | Aperture | 13.99 | | |
| | Stop | | | |
| 22 | −32.96 | 5.71 | 1.51 | 60.74 |
| 23 | −270.01 | 8.97 | | |
| 24 | −379.49 | 14.34 | 1.75 | 28.15 |
| 25 | −67.23 | 1.24 | | |
| 26 | 211.55 | 19.56 | 1.58 | 57.81 |
| 27 | −76.67 | 0.52 | | |
| 28 | 59.11 | 17.64 | 1.62 | 60.34 |
| 29 | 1974.65 | 6.99 | | |
| 30 | −254.08 | 5.06 | 1.76 | 27.58 |
| 31 | 66.65 | 17.14 | | |
| 32 | −70.16 | 8.91 | 1.74 | 37.46 |
| 33 | −47.20 | 4.82 | | |
| 34 | −41.79 | 5.00 | 1.51 | 63.55 |
| 35 | 327.69 | 20.12 | | |
| 36 | −38.88 | 6.83 | 1.76 | 27.58 |
| 37 | −156.16 | 4.60 | | |
| 38 | −158.31 | 22.61 | 1.74 | 42.70 |
| 39 | −61.08 | 0.76 | | |
| 40 | 353.15 | 19.11 | 1.69 | 49.27 |
| 41 | −226.39 | 17.00 | | |
| Image | | | | |
| Plane | | | | |

Aspheric Coefficient

| Surface | | | | | | | | |
|---|---|---|---|---|---|---|---|---|
| Number | k | a | b | c | d | e | f | g |
| 1, 7 | 0.00E+00 | 3.34E−09 | −6.39E−14 | 1.16E−17 | −6.40E−22 | 3.18E−26 | −8.25E−31 | 1.39E−35 |
| 4, 10 | 0.00E+00 | 2.84E−09 | 8.32E−14 | 2.31E−18 | 5.53E−18 | 2.20E−27 | −2.72E−32 | 3.42E−36 |
| 17 | 0.00E+00 | 2.63E−06 | 1.40E−09 | 7.01E−13 | −1.09E−15 | 4.86E−21 | 0.00E+00 | 0.00E+00 |
| 20 | 0.00E+00 | 2.00E−07 | 7.27E−10 | 2.34E−13 | −1.64E−16 | 1.59E−19 | 0.00E+00 | 0.00E+00 |
| 25 | 0.00E+00 | 1.29E−07 | 1.70E−10 | 8.52E−14 | −7.32E−18 | 1.41E−20 | 0.00E+00 | 0.00E+00 |
| 31 | 0.00E+00 | 1.88E−06 | −2.56E−11 | −3.02E−14 | 1.52E−16 | −1.16E−19 | 0.00E+00 | 0.00E+00 |
| 41 | 0.00E+00 | −3.08E−07 | 6.47E−12 | 6.76E−15 | −1.23E−18 | 8.25E−23 | 0.00E+00 | 0.00E+00 |

### NUMERICAL EXAMPLE 4

Rapl = 145.96
RM2a = −122.05
νM2 = 52.43

| Surface | | | | |
|---|---|---|---|---|
| Number | r | d | Nd | νd |
| Object | | 13.39 | | |
| Plane | | | | |
| 1 | 819.00 | 16.40 | 1.49 | 70.24 |
| 2 | −3201.41 | 28.35 | | |
| 3 | ∞ | 13.97 | 1.49 | 70.24 |
| 4 | ∞ | 68.55 | | |
| 5 | −122.05 | 9.54 | 1.52 | 52.43 |
| 6 | −172.82 | −9.54 | 1.52 | 52.43 |
| 7 | −122.05 | −68.55 | | |
| 8 | ∞ | −13.97 | 1.49 | 70.24 |
| 9 | ∞ | −28.35 | | |
| 10 | −3201.41 | −16.40 | 1.49 | 70.24 |
| 11 | −819.00 | 16.40 | 1.49 | 70.24 |
| 12 | −3201.41 | 28.35 | | |
| 13 | ∞ | 13.97 | 1.49 | 70.24 |
| 14 | ∞ | 68.55 | | |
| 15 | −122.05 | 9.54 | 1.52 | 52.43 |
| 16 | −172.82 | 10.00 | | |
| 17 | 126.58 | 6.22 | 1.74 | 44.85 |
| 18 | −950.12 | 9.32 | | |
| 19 | −64.86 | 5.00 | 1.68 | 31.36 |
| 20 | 537.54 | 8.74 | 1.62 | 60.32 |
| 21 | −56.79 | 0.50 | | |
| 22 | 82.22 | 7.50 | 1.49 | 70.41 |
| 23 | 635.34 | 23.00 | | |
| 24 | 64.84 | 14.27 | 1.69 | 49.87 |
| 25 | 618.89 | 5.01 | 1.76 | 27.58 |
| 26 | 709.49 | 10.48 | | |
| 27 | −96.82 | 8.38 | 1.75 | 34.46 |
| 28 | −68.50 | 28.14 | | |
| 29 | Aperture | 48.00 | | |
| | Stop | | | |
| 30 | −577.36 | 14.75 | 1.74 | 44.85 |
| 31 | −104.66 | 0.50 | | |
| 32 | 116.63 | 19.70 | 1.74 | 44.85 |
| 33 | −222.26 | 0.50 | | |
| 34 | 65.69 | 7.94 | 1.74 | 27.58 |
| 35 | 70.78 | 13.16 | | |
| 36 | −483.66 | 5.00 | 1.74 | 28.39 |
| 37 | 53.97 | 51.45 | | |
| 38 | −43.90 | 5.00 | 1.62 | 36.83 |
| 39 | −429.14 | 6.13 | | |
| 40 | −138.53 | 17.04 | 1.74 | 44.50 |
| 41 | −58.87 | 0.50 | | |
| 42 | 357.86 | 13.06 | 1.74 | 44.85 |
| 43 | −313.15 | 10.50 | | |
| Image | | | | |
| Plane | | | | |

Aspheric Coefficient

| Surface | | | | | | | | |
|---|---|---|---|---|---|---|---|---|
| Number | k | a | b | c | d | e | f | g |
| 1, 11 | 0.00E+00 | 7.19E−09 | −2.15E−14 | 3.31E−17 | −2.42E−21 | 2.45E−25 | −1.36E−29 | 4.52E−34 |
| 6, 16 | 0.00E+00 | 5.09E−09 | 2.20E−13 | 8.31E−18 | 2.05E−22 | 1.85E−26 | −4.31E−31 | 3.56E−35 |
| 23 | 0.00E+00 | 1.03E−06 | 1.79E−11 | −3.63E−14 | 3.77E−17 | 1.29E−20 | 0.00E+00 | 0.00E+00 |
| 26 | 0.00E+00 | 7.92E−07 | 2.89E−10 | 1.07E−M | −1.21E−17 | 2.23E−21 | 0.00E+00 | 0.00E+00 |
| 33 | 0.00E+00 | 1.89E−07 | −4.72E−12 | −2.07E−16 | −9.83E−20 | 3.27E−23 | 0.00E+00 | 0.00E+00 |
| 37 | 0.00E+00 | 2.31E−07 | −2.63E−11 | −2.63E−14 | 2.69E−17 | −9.30E−21 | 0.00E+00 | 0.00E+00 |
| 43 | 0.00E+00 | −5.54E−07 | 1.02E−10 | −2.53E−14 | 8.33E−19 | 3.66E−22 | 0.00E+00 | 0.00E+00 |

TABLE 1

| | Numerical Example | | | |
|---|---|---|---|---|
| Condition | 1 | 2 | 3 | 4 |
| (1) Rapl | 87.52 | 147.19 | 142.21 | 145.96 |
| RM2a | −87.05 | −118.31 | −167.82 | −122.05 |
| (2) vM2 | 40.75 | 70.24 | 52.43 | 52.43 |

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-200546 filed Sep. 14, 2011, which is hereby incorporated by reference herein in its entirety.

What is claimed is:

1. A catadioptric system, comprising:
a catadioptric unit configured to collect a light flux from an object to form an intermediate image of the object;
a field lens unit disposed at a position where the intermediate image is formed; and
a dioptric unit configured to focus the intermediate image on an image plane,
wherein the catadioptric unit includes, in order from an object side to an image side:
a first optical element including a first transmissive unit having positive refractive power disposed in the vicinity of an optical axis and, on the object side thereof, a first reflective unit disposed at an outer circumference relative to the first transmissive unit and having a reflective surface, and
a second optical element including a second transmissive unit having negative refractive power in the vicinity of the optical axis and, on the image side thereof, a second reflective unit disposed at an outer circumference relative to the second transmissive unit and having a reflective surface,
wherein the light flux from the object sequentially travels through the first transmissive unit, to the second reflective unit, to the first reflective unit, and to the second transmissive unit to exit toward the field lens unit, and
wherein, when radii of curvature of an object-side surface and an image-side surface of the second optical element are denoted by RM2a and RM2b, respectively, a thickness of the second optical element along the optical axis is denoted by t, a refractive index of a material of the second optical element with respect to a wavelength of 587.6 nm is denoted by Nd, and following equations are defined:
$$\frac{1}{( \frac{\vert RM 2 b \vert}{2} )} - \frac{1}{( \vert RM 2 a \vert + t )} = \frac{1}{{s}^{′}}$$
$$\frac{( {s}^{′} - t ) \times Nd}{( Nd + 1 )} = Rapl$$
following condition is satisfied:
Rapl×0.8<|RM2a|<Rapl×1.2.

2. The catadioptric system according to claim 1, wherein, when an Abbe number of a glass material of the second optical element is denoted by νM2, following condition is satisfied:
νM2>40.

3. The catadioptric system according to claim 1, where the reflective surface of the second reflective unit has an aspheric shape.

4. The catadioptric system according to claim 1, wherein the object side and the image plane side are configured to be telecentric.

5. The catadioptric system according to claim 1, wherein an aperture stop is disposed in the catadioptric unit.

6. The catadioptric system according to claim 1, wherein the reflective surface of the first reflective unit and the reflective surface of the second reflective unit are disposed to face each other.

7. The catadioptric system according to claim 1, wherein the reflective surface of the second optical element has an aspheric shape and the curvature thereof is continuous over a range from the light transmissive unit to the outer edge of the outer circumference.

8. The catadioptric system according to claim 1, wherein the object-side surface of the first optical element has a convex shape.

9. The catadioptric system according to claim 1, wherein the second optical element has a meniscus shape having a concave surface on the object side thereof.

10. An image pickup apparatus, comprising:
a light source unit;
an illumination optical system configured to illuminate an object with a light flux from the light source unit;
a catadioptric system configured to form an image of the object; and
an image sensor configured to photo-electrically convert the image of the object formed by the catadioptric system; and
an image processing system configured to generate image information using a signal from the image sensor,
wherein the catadioptric system includes:
a catadioptric unit configured to collect a light flux from the object to form an intermediate image of the object;
a field lens unit disposed at a position where the intermediate image is formed; and
a dioptric unit configured to focus the intermediate image on an image plane,
wherein the catadioptric unit includes, in order from an object side to an image side,
a first optical element including a first light transmissive unit having positive refractive power disposed in the vicinity of an optical axis and, on the object side thereof, a first reflective unit disposed at an outer circumference relative to the first light transmissive unit and having a reflective surface, and
a second optical element including a second light transmissive unit having negative refractive power in the vicinity of the optical axis and, on the image side thereof, a second reflective unit disposed at an outer circumference relative to the second light transmissive unit and having a reflective surface,
wherein the reflective surface of the first reflective unit and the reflective surface of the second reflective unit are disposed to face each other,
wherein the light flux from the object sequentially travels through the first light transmissive unit, to the second reflective unit, to the first reflective unit, and through the second light transmissive unit to exit toward the field lens unit, and
wherein, when radii of curvature of an object-side surface and an image-side surface of the second optical element are denoted by RM2a and RM2b, respectively, a thickness of the second optical element along the optical axis is denoted by t, a refractive index of a material of the second optical element with respect to a wavelength of 587.6 nm is denoted by Nd, and following equations are defined:
$$\frac{1}{( \frac{\vert RM 2 b \vert}{2} )} - \frac{1}{( \vert RM 2 a \vert + t )} = \frac{1}{{s}^{′}}$$
$$\frac{( {s}^{′} - t ) \times Nd}{( Nd + 1 )} = Rapl$$
following condition is satisfied:
Rapl×0.8<|RM2a|<Rapl×1.2.
